(19) United States
(12) Patent Application Publication
(10) Pub. No.: US 2007/0098536 A1
(43) Pub. Date: May 3, 2007

(54) EXTENDABLE TELESCOPING BOOM AND METHOD OF MANUFACTURING

(76) Inventor: ROGER D. KOOIMA, Canton, SD (US)

Correspondence Address: MCKEE, VOORHEES & SEASE, P.L.C., 801 GRAND AVENUE, SUITE 3200, DES MOINES, IA, 50309-2721, US

(21) Appl. No.: 11/550,561

(22) Filed: Oct. 18, 2006

Related U.S. Application Data
(60) Provisional application No. 60/731,767, filed on Oct. 31, 2005.

(51) Int. Cl. B60P 3/12

(52) U.S. Cl. 414/563

(57) ABSTRACT

The present invention provides an extendable telescoping boom having one or more telescoping sections which nest inside one another allowing the boom to extend and retract. Along the surfaces of the boom sections are one or more sunken pockets in the surface of the boom sections which contain one or more wear pads attached within one or more sunken pockets allowing the multiple boom sections to slide linearly one inside the other with a reduced gap between the boom sections. A method of manufacturing an extendable telescoping boom assembly is also provided.

### PRIORITY STATEMENT

This application claims priority to U.S. Provisional Patent Application No. 60/731,767 filed Oct. 31, 2005, herein incorporated by reference in its entirety.

### BACKGROUND OF THE INVENTION

This invention relates to an extendable telescoping boom and method of manufacturing. This invention will be shown as an extendable telescoping boom and lift assembly that can be attached to a towing vehicle and used to lift and tow other vehicles. However, the extendable telescoping boom and method of manufacturing can be used with any application requiring an extendable telescoping boom.

Telescoping booms are common in industry for creating a long boom which can store and travel in a shorter space. Typically, the boom sections are greased with a lubricant so that the multiple sections can slide inside one another easily with reduced friction. Additionally, some telescoping booms have external mechanisms welded or affixed to the boom sections to hold wear pads which allow wear pads to reduce the friction between the sliding telescoping parts. However, attaching external mechanisms to hold the wear pads between the nesting, telescoping parts, creates a large clearance gap between the two or more parts which nest immediately inside one another. This large clearance gap allows dirt and other debris to gather between the telescoping parts and cause friction and premature wear of the parts.

In light of the foregoing problems with telescoping booms, it is desirable to have an improved extendable telescoping boom and method of manufacturing.

Therefore, the primary feature or advantage of the present invention is to provide an improved extendable telescoping boom and method of manufacturing.

Another feature or advantage of the present invention is the provision of a telescoping boom which provides smaller clearance between boom elements or parts.

Another feature or advantage of the present invention is an extendable telescoping boom which is easier to manufacture than current designs.

Still another feature or advantage of the present invention is an extendable telescoping boom which can be more precisely manufactured due to tighter tolerances.

Yet another feature or advantage of the present invention is an extendable telescoping boom which has a better fit between boom sections.

A further feature or advantage of the present invention is an extendable telescoping boom with wear pads that are cheaper to make and easier to replace.

A further feature or advantage of the present invention is a method of manufacturing an extendable telescoping boom.

A still further feature or advantage of the present invention is a provision of an extendable telescoping boom which is economical to manufacture, durable in use and efficient in operation.

One or more of these and/or other features or advantages of the invention will be apparent from the specification and claims that follow.

### BRIEF SUMMARY OF THE INVENTION

One or more of the foregoing features or advantages may be achieved by an extendable telescoping boom having a first boom section with an opening at an end and running linearly inside the first boom section, a second boom section which slideably nests within the opening of the first boom section and slides linearly within the opening and one or more wear pads attached within one or more sunken pockets inside the first boom section and arranged to allow the second boom section to slide linearly inside the first boom section. Alternatively, the one or more wear pads may be attached within one or more sunken pockets outside of the second boom section and arranged to allow the second boom section to slide linearly inside the first boom section. Additionally, the one or more wear pads may be attached within one or more sunken pockets inside the first boom section and within one or more sunken pockets outside of the second boom section and arranged to allow the second boom section to slide linearly inside the first boom section. Any number of boom sections nested together in similar fashion may be used.

One or more of the foregoing features or advantages may also be achieved by a lifting vehicle having an extendable telescoping boom which has nestable sliding sections with sunken pockets and wear pads attached within the sunken pockets to guide the sliding of the nested parts to extend and retract the telescoping boom.

One or more of the foregoing features or advantages may also be achieved by a method of making a telescoping boom by creating one or more sunken pockets inside a first boom section, attaching one or more wear pads in the one or more sunken pockets in the first boom section, creating one or more sunken pockets outside of the second boom section, attaching one or more wear pads in the one or more sunken pockets in the second boom section, and inserting the second boom section inside the first boom section so that the second boom section slides linearly inside the first boom section gliding on the one or more wear pads.

### BRIEF DESCRIPTION OF THE FIGURES AND DRAWINGS

FIG. 1 is an isometric view of one embodiment of the current invention integrated onto a towing vehicle boom lift assembly.

FIG. 2 is an exploded isometric view of multiple sections of one embodiment of an extendable telescoping boom assembly.

FIG. 2A is an enlarged view of a portion of FIG. 2.

FIG. 2B is an enlarged view of a portion of FIG. 2.

FIG. 2C is an enlarged view of a portion of FIG. 2B.

FIG. 3 is a plan view of one embodiment of an extendable telescoping boom.

FIG. 3A is an enlarged view of a portion of FIG. 3.

FIG. 4 is a sectional view along lines 4-4 of FIG. 3.

FIG. 4A is an enlarged view of a portion of FIG. 4.

### DETAILED DESCRIPTION OF THE PREFERRED EMBODIMENT

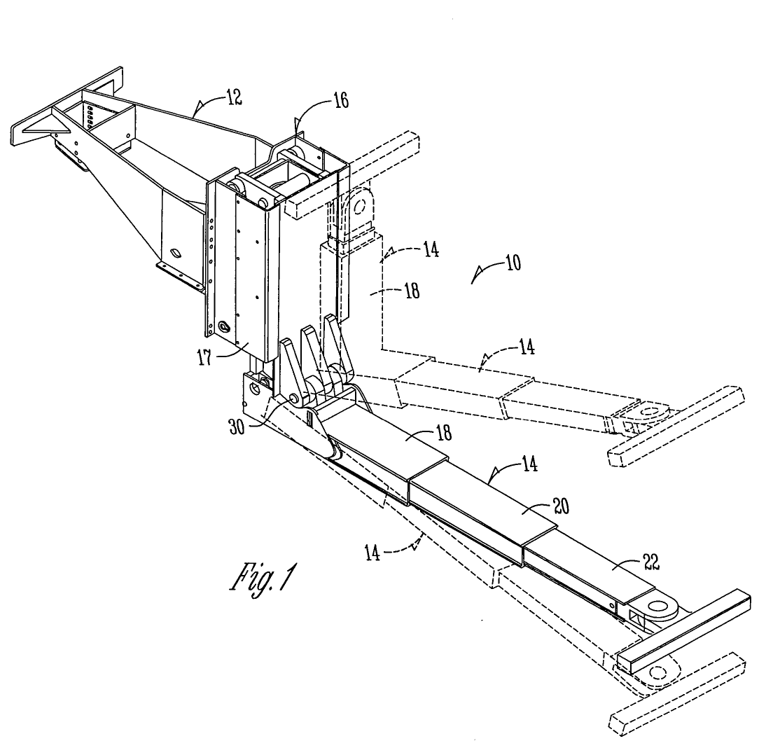

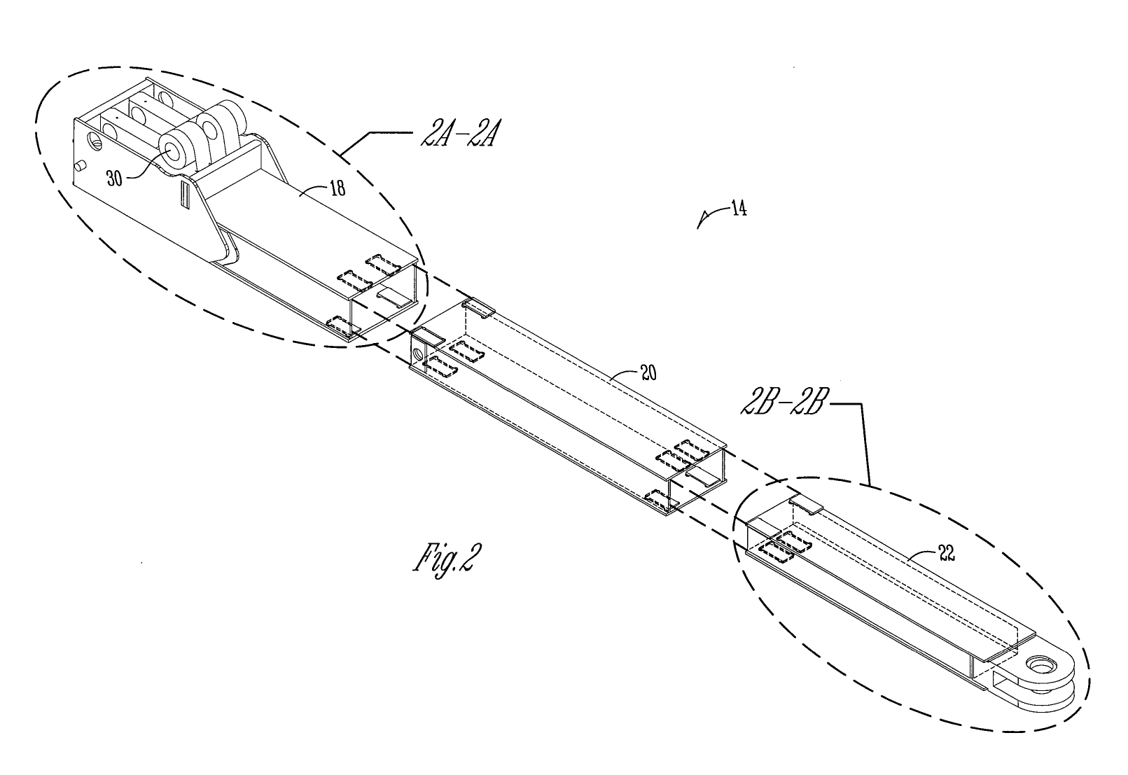

FIG. 1 shows one embodiment of a tilt recovery auto lift system assembly 10 of the current invention. The lift system 10 is a device which mounts to a towing vehicle (not shown) and connects to and lifts a vehicle which is to be towed (not shown). A hydraulic cylinder assembly (not shown) for tilting a boom 14 allows the boom 14 to be raised and lowered, for use and stowing. The current invention is shown and described as an auto lift system, however the current invention can be used on any telescoping boom assembly, such as cranes, lifts, elevators, and the like.

FIG. 1 shows the lift system 10 with the boom assembly 14 in multiple positions. The boom 14 is a telescoping boom assembly. In addition, the lift system assembly 10 generally comprises a vehicle towing attachment assembly 12. The vehicle towing attachment assembly 12 preferably has a kingpin for attaching to a towing vehicle (not shown) at a fifth wheel plate of a road tractor. The preferred towing vehicle attachment assembly 12 is similar that shown in U.S. Pat. Nos. 5,823,735 and 6,036,428 and application Ser. No. 11/216,266 for Kooima, which are herein incorporated by reference in their entirety. However, any towing vehicle attachment assembly 12 which allows the tilt recovery auto lift system assembly 10 of the current invention to be attached to a towing vehicle will work with the current invention. In addition, the boom assembly 14 can be used for any device requiring an extendable boom, not just for towing devices.

This embodiment of the invention also has a boom lift assembly 16 which attaches to a boom lift assembly mounting frame 17 and preferably uses one or more vertical hydraulic lift cylinders (not shown) for raising and lowering the boom lift assembly 16 and the boom assembly 14. The boom assembly 14 pivots at the boom pivot point 30 for stowing.

The telescoping boom assembly 14, as shown in the figures, has three sections. A first boom section 18, a second boom section 20, and a third boom section 22. As shown in the figures, the third boom section 22 fits inside the second boom section 20, which, in turn, fits inside the first boom section 18. Preferably, a hydraulic cylinder is used for extending and retracting these boom sections 18, 20 and 22 within one another. However, any method or device can be used for extending the boom assembly 14.

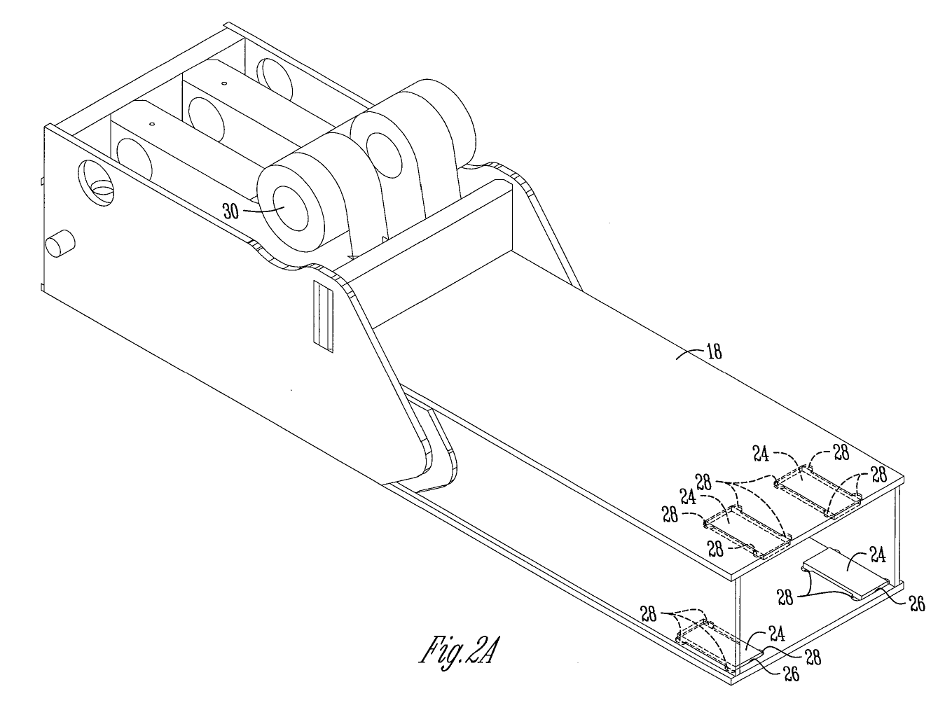

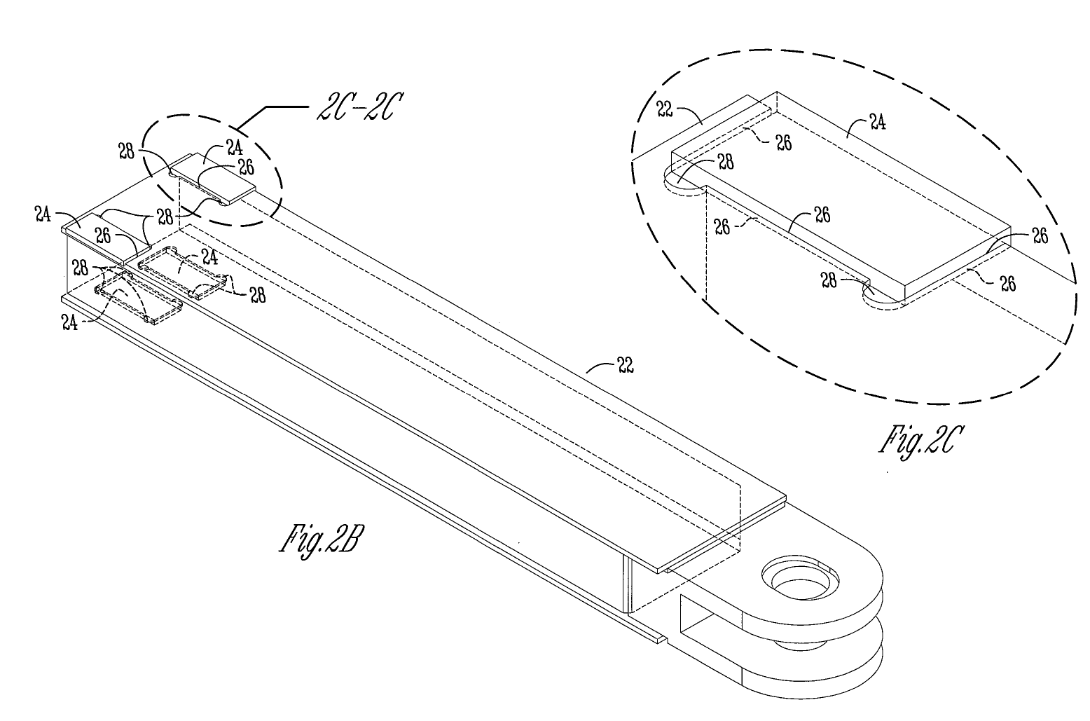

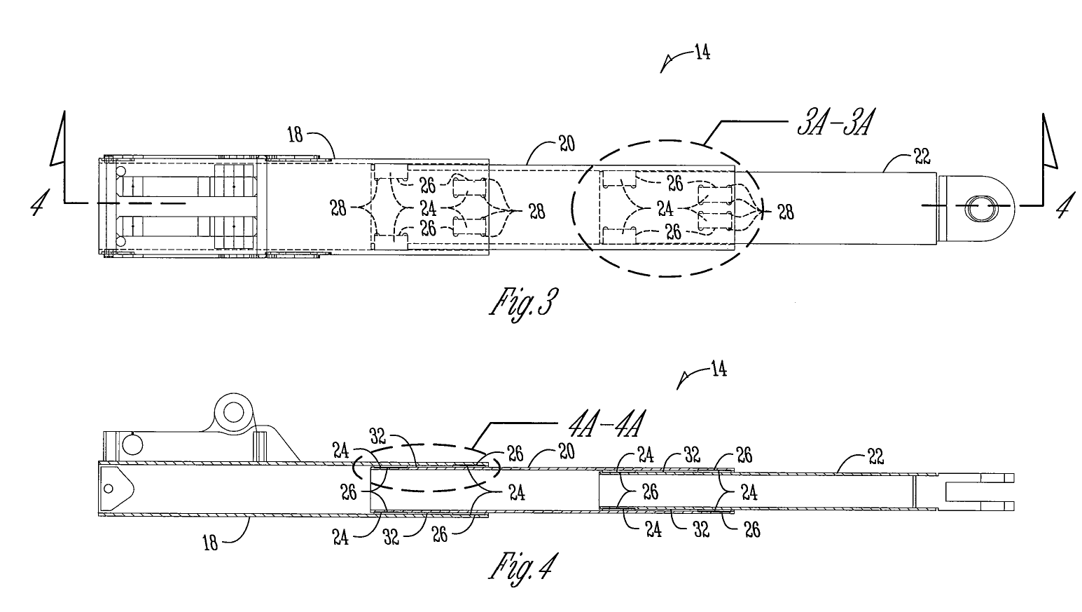

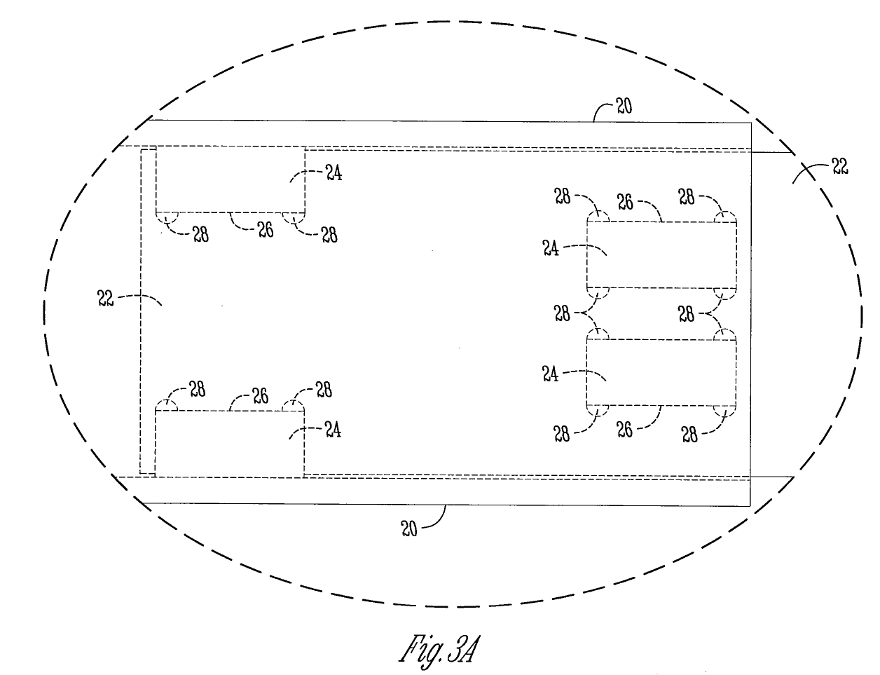

FIG. 2 shows an exploded view of one embodiment of the boom assembly 14. Shown in FIG. 2 and expanded in FIGS. 2A, 2B and 2C are a number of wear pads 24 attached within sunken pockets 26. In this embodiment, the wear pads 24 are preferably constructed from nylon, brass, rubber, Teflon, polyethylene, or etc. and are used to make the sections 18, 20, 22, slide easier inside one another and give a surface to wear that can be readily replaced. The sunken pockets 26 and wear pads 24 are located so that as the third boom section 22 enters the inside of the second boom section 20 and the second boom section 20 enters the inside of the first boom section 18, the wear pads, which extend above the sunken pockets 26 do not interfere with the wear pads on the mating-telescoping section 18, 20, 22, as best seen in FIGS. 2 and 3. Additionally, the wear pads 24 located on the upper portion of the third boom section 22 and the second boom section 20 nearest the first boom section 18 are located on outward edges of the respective boom sections 20, 22 to not only allow wear and guiding assistance along the upper and lower portions of the boom sections 18-22, but also to allow lateral wear and guiding assistance between the sections 18-22. FIGS. 3 and 3A also show pocket lobes 28 which are part of the sunken pocket 26 which extends within the surface of the boom sections 18-22. Pocket lobes 28 come from overrun on milling the pocket 26 with a round cutter. This overrun allows for square corner wear pads 24 to be used and fitted into the pocket 26. The lobes 28 are not necessary in the pocket 26. It is preferred that the wear pads 24 fit snugly into the pockets 26. Any shape of wear pad 24 and pocket 26 is allowable.

Preferably the wear pads 24 can stay in the pockets 26 with a friction fit and then the mating parts 18, 20, 22 will hold them in place after assembly of the boom assembly 14. However other methods can be used to hold the wear pads 24 in place, including, but not limited to, adhesives, mechanical fasteners and etc.

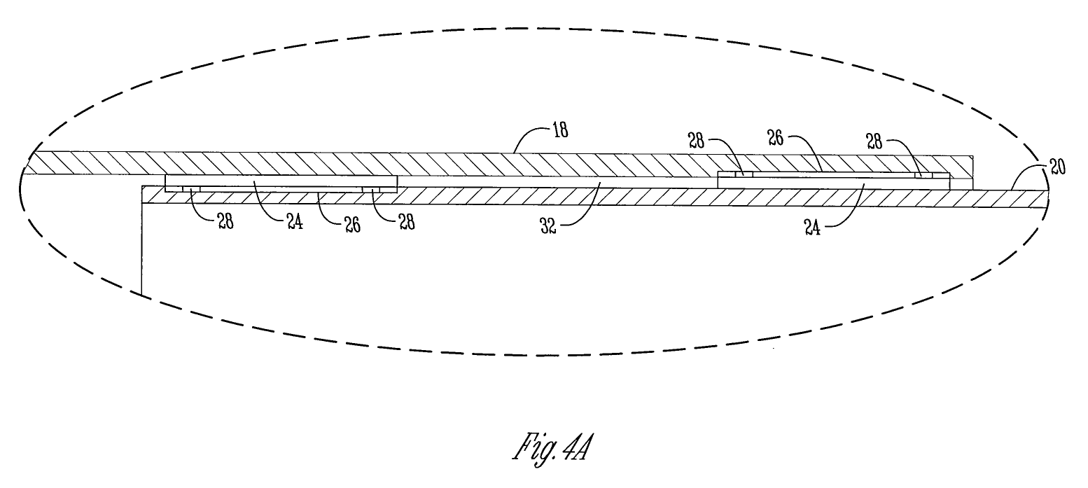

FIGS. 4 and 4A show how the sunken pockets 26 and the wear pads 24 are preferably located in the boom sections 18-22. As can be seen in these figures, the sunken pocket 26 can be milled, stamped, molded, etched and etc. into the respective boom sections 18-22 to allow the wear pads 24 to be affixed within the sunken pocket. As best seen in FIG. 4A, a clearance gap 32 is required between the boom sections 18-20 and 20-22. Having a clearance gap 32 is common in the art with telescoping boom sections. However using a sunken pocket 26 with wear pads 24 allows the clearance gap 32 to be reduced creating better tolerance boom assemblies 14. As best seen in FIGS. 2B and 2C, the wear pads 24 located on the end of the third boom section 22 which enters into the second boom section 20, are located on the outer lateral edge of the boom section 22. This allows for guideability and wear resistance both vertical and lateral when the boom sections 18-22 are extended and contracted.

It is noted that any number of boom sections 18-22 can be used with the current invention. Additionally, any number of sunken pockets 26 and wear pads 24 can be used, and can be used in any arrangement on the boom sections 18-22. It is also preferred that the boom sections 18-22 be constructed of rigid material, such as steel, to allow the boom assembly 14 to expand and contract while remaining strong enough for the boom's 14 intended purpose.

A pocket cut out 26 of the boom section 18-22 to hold the wear pad 24 does several things. It allows the boom sections 18-22 to be fitted together with a much smaller clearance gap 32 between boom elements 18-22. It allows easier manufacturing methods of the boom assembly 14. It allows a more precise method of manufacturing, which allows better fit between boom sections 18-22 and, it allows introducing wear pads 24 that are cheaper to make and easier to replace than traditional wear pads. The wear pads 24 can simply be pieces of the wear pad 24 material which fit the pockets 26.

Because the pocket 26 is cut out or counter sunken into the boom section 18-22, there is no need to weld or provide an external mechanism to hold the wear pads 24. Such mechanisms, if applied take up considerable amount of room and have to be allowed for when planning for the wear thickness of the wear pad 24. This can amount to doubling the gap 32 needed between boom sections 18-20 and 20-22. Also, if the wear pad 24 is made with a “nutsert” or other fastening method imbedded into the wear pad 24 surface, that too has to be considered for the wear portion of the wear pad 24, may double the spacing between the boom sections, and costs more to make which is undesirable.

When milling the pocket 26 for the wear pad 24, more precision can be maintained so the fit of the boom sections 18-22 will be more precise which will allow easier fit-up and more precise extension of the boom 14. The pocket 26 can be provided by other means than milling, such as , but not limited to laser cutting, or cutting by any method completely through the material, then adding a back-up plate (not shown). However, in multiple telescoping boom sections, this would defeat the purpose of milling the pocket 26 through only part of the material.

In the embodiment illustrated, the wear pads 24 are made of moly filled nylon which is ⅜″ thick. The pocket 26 in the boom sections 18-22 are ⅛41 deep, which leaves ¼″ of wear pad 24 exposed. This ¼″ can be completely worn down before the boom sections 18-22 contact one another. The gap 36 in the boom sections 18-22 is only ¼″ giving the maximum wear surface for the amount of gap 32 needed. The boom sections 18-22 are preferably made so the pads 24 contact the surfaces of the boom section 18-22 as extreme to the strongest cross section as possible, i.e. where the vertical boom section mates with the horizontal section of the boom. This will allow for greatest strength where the wear pad 24 comes in contact with the boom section 18-22. This will prevent the boom section 18-22 from ‘oil canning’ in the area of contact. The pad also preferably ‘overhangs’ the inner boom section to give the boom a side-to-side wear plate, the wear pad 24 making contact with the outer boom section instead of the metal-to-metal wear between boom sections.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An extendable telescoping boom comprising:
a first boom section having an opening at an open end and running linearly inside the first boom section;
a second boom section which slideably nests within the opening of the first boom section and slides linearly within the opening; and
one or more wear pads attached within one or more sunken pockets inside the first boom section and arranged to allow the second boom section to slide linearly inside the first boom section sliding on the wear pads.

2. An extendable telescoping boom comprising:
a first boom section having an opening at an open end and running linearly inside the first boom section;
a second boom section which slideably nests within the opening of the first boom section and slides linearly within the opening; and
one or more wear pads attached within one or more sunken pockets outside of the second boom section and arranged to allow the second boom section to slide linearly inside the first boom section sliding on the wear pads.

3. An extendable telescoping boom comprising:
a first boom section having an opening at an open end and running linearly inside the first boom section;
a second boom section which slideably nests within the opening of the first boom section and slides linearly within the opening;
one or more wear pads attached within one or more sunken pockets inside the first boom section and arranged to allow the second boom section to slide linearly inside the first boom section sliding on the wear pads; and
one or more wear pads attached wherein one or more sunken pockets outside of the second boom section and arranged to allow the second boom section to slide linearly inside the first boom section sliding on the wear pads.

4. A vehicle having an extendable telescoping boom comprising:
a first boom section having an opening at an open end and running linearly inside the first boom section;
a second boom section which slideably nests within the opening of the first boom section and slides linearly within the opening;
one or more wear pads attached within one or more sunken pockets inside the first boom section and arranged to allow the second boom section to slide linearly inside the first boom section sliding on the wear pads; and
one or more wear pads attached wherein one or more sunken pockets outside of the second boom section and arranged to allow the second boom section to slide linearly inside the first boom section sliding on the wear pads.

5. A method of making a telescoping boom comprising:
creating one or more sunken pockets inside a first boom section;
attaching one or more wear pads in the one or more sunken pockets in the first boom section;
creating one or more sunken pockets outside a second boom section;
attaching one or more wear pads in the one or more sunken pockets in the second boom section; and
inserting the second boom section inside the first boom section so that the second boom section slides linearly inside the first boom section gliding on the one or more wear pads.
